(19) United States
(12) Patent Application Publication
(10) Pub. No.: US 2022/0059046 A1
(43) Pub. Date: Feb. 24, 2022

(54) DISPLAY DEVICE

(71) Applicant: SHARP KABUSHIKI KAISHA, Osaka (JP)

(72) Inventors: TOYOHITO NISHIKAWA, Osaka (JP); TAKASHI SASAKI, Osaka (JP)

(21) Appl. No.: 17/365,606

(22) Filed: Jul. 1, 2021

Related U.S. Application Data
(60) Provisional application No. 63/068,703, filed on Aug. 21, 2020.

(51) Int. Cl. G09G 3/36

(52) U.S. Cl. CPC G09G 3/3688; G02F 1/1368; G09G 2330/027; G09G 2320/0257

(57) ABSTRACT

A display device includes a display panel including a plurality of data lines, a plurality of pixel circuits, and a common electrode and a data line drive circuit including a plurality of data output terminals each configured to output a voltage to be applied to each of the plurality of data lines and configured to short all the plurality of data output terminals when receiving the power supply off instruction. The plurality of data output terminals are classified into use terminals electrically connected to the plurality of data lines and unused terminals not electrically connected to the plurality of data lines. At least some of the unused terminals are electrically connected to either the ground or the common electrode.

### CROSS-REFERENCE TO RELATED APPLICATIONS

This application claims the benefit of priority to U.S. Provisional Application No. 63/068,703 filed on Aug. 21, 2020. The entire contents of the above-identified application are hereby incorporated by reference.

### BACKGROUND

### Technical Field

The disclosure relates to a display device, such as a liquid crystal display device.

Liquid crystal display devices are widely used as thin, lightweight, and low power consumption display devices. The liquid crystal panel included in the liquid crystal display device has a structure in which liquid crystal is sandwiched between two glass substrates. One of the glass substrates is formed with a plurality of scanning lines, a plurality of data lines, and a plurality of pixel circuits each including a thin film transistor (hereinafter referred to as “TFT”) and a pixel electrode. The other of the glass substrates is formed with a common electrode facing all the plurality of pixel electrodes. Hereinafter, the former is referred to as a TFT substrate, and the latter is referred to as a counter substrate. Some liquid crystal panels include both the plurality of pixel circuits and the common electrode formed on one of the glass substrates.

In recent years, a technology for forming the TFT in the pixel circuit using an oxide semiconductor has been put to practical use. The TFT using the oxide semiconductor has a characteristic in that an off current is small. Thus, in the liquid crystal display device including the TFT using the oxide semiconductor, the voltage written to the pixel circuit is kept at a level at the time of writing for a long period of time. Thus, according to such a liquid crystal display device, writing to the pixel circuit can be reduced, and power consumption can be reduced when a still image is displayed. As the oxide semiconductor, for example, Indium Gallium Zinc Oxide (IGZO) is used.

Hereinafter, the operation of the liquid crystal display device when the power supply is turned off will be discussed. The liquid crystal display device includes a data line drive circuit configured to drive a plurality of data lines. The data line drive circuit includes a plurality of terminals (hereinafter referred to as data output terminals) for outputting a voltage to be applied to each of the plurality of data lines. In a case where the power supply is turned off, if the operation of the liquid crystal display device is stopped in a state in which potentials of the plurality of data output terminals are different from each other, a noise may occur on a display screen after the power supply is turned off. Thus, the data line drive circuit shorts all the data output terminals when receiving a power supply off instruction.

As described above, the off current of the TFT using the oxide semiconductor is small. Thus, in the liquid crystal display device including the TFT using the oxide semiconductor, a charge remains in the pixel electrode even after the power supply is turned off, and an afterimage may be displayed on the display screen after the power supply is turned off. Accordingly, in the liquid crystal display device including the TFT using the oxide semiconductor, a data line drive circuit that sets all the data output terminals to the same potential as that of the common electrode when receiving the power supply off instruction needs to be used. However, in a case where the liquid crystal display device has a function of setting the potential of the common electrode to the ground level when receiving the power supply off instruction, a data line drive circuit that sets the potential of all the data output terminals to the ground level may also be used. Hereinafter, a process in which all the data output terminals are set to the same potential as that of the common electrode or the ground when the power supply is turned off is referred to as a discharge.

WO 2014/50719 describes a liquid crystal display device configured to set a standby period before the power supply is turned off and to set all the gray scaly reference voltages to the same level in the standby period when receiving the power supply off instruction in order to prevent an afterimage from being displayed on the display screen after the power supply is turned off. However, in the liquid crystal display device described in the above publication, only the data line drive circuit having the discharging function can be used.

### SUMMARY

Accordingly, an object is to provide a display device that can perform the discharge even when a data line drive circuit having no discharging function is used.

(1) A display device according to some embodiments of the disclosure includes a display panel including a plurality of data lines, a plurality of pixel circuits, and a common electrode and a data line drive circuit including a plurality of data output terminals each configured to output a voltage to be applied to each of the plurality of data lines and configured to short all the plurality of data output terminals when receiving a power supply off instruction, wherein the plurality of data output terminals are classified into use terminals electrically connected to the plurality of data lines and unused terminals not electrically connected to the plurality of data lines, and at least some of the unused terminals are electrically connected to either the ground or the common electrode.

In the above-described display device, at least some of the unused terminals are electrically connected to the ground or the common electrode, and the data line drive circuit shorts all the data output terminals when receiving the power supply off instruction. Thus, when the power supply is turned off, all the data output terminals become the same potential as that of the common electrode or the ground. Accordingly, even when a data line drive circuit having no discharging function is used, the discharge can be performed.

(2) A display device according to some embodiments of the disclosure has the above-described configuration (1), wherein all the unused terminals are electrically connected to the ground.

(3) A display device according to some embodiments of the disclosure has the above-described configuration (2), and further includes a circuit configured to set a potential of the common electrode to the ground level when receiving the power supply off instruction.

(4) A display device according to some embodiments of the disclosure has the above-described configuration (1), wherein some of the unused terminals are electrically connected to the ground, and the remaining unused terminals are electrically connected to the common electrode.

(5) A display device according to some embodiments of the disclosure has the above-described configuration (1), wherein all the unused terminals are electrically connected to the common electrode.

(6) A display device according to some embodiments of the disclosure has the above-described configuration (1), wherein some of the unused terminals are electrically connected to the ground.

(7) A display device according to some embodiments of the disclosure has the above-described configuration (6), and further includes a circuit configured to set a potential of the common electrode to the ground level when receiving the power supply off instruction.

(8) A display device according to some embodiments of the disclosure has the above-described configuration (1), wherein some of the unused terminals are electrically connected to the ground, and the remaining some of the unused terminals are electrically connected to the common electrode.

(9) A display device according to some embodiments of the disclosure has the above-described configuration (1), wherein some of the unused terminals are electrically connected to the common electrode.

(10) A display device according to some embodiments of the disclosure has the above-described configuration (1), wherein the display panel is a liquid crystal panel.

(11) A display device according to some embodiments of the disclosure has the above-described configuration (1), wherein each of the plurality of pixel circuits includes a thin film transistor formed using an oxide semiconductor.

(12) A display device according to some embodiments of the disclosure has the above-described configuration (11), wherein the oxide semiconductor is indium gallium zinc oxide.

(13) A display device according to some embodiments of the disclosure includes a display panel including a plurality of data lines and a plurality of pixel circuits and a data line drive circuit including a plurality of data output terminals each configured to output a voltage to be applied to each of the plurality of data lines and configured to short all the plurality of data output terminals when receiving a power supply off instruction, wherein the plurality of data output terminals are classified into use terminals electrically connected to the plurality of data lines and unused terminals not electrically connected to the plurality of data lines, and at least some of the unused terminals are electrically connected to the ground.

In the above-described display device, at least some of the unused terminals are electrically connected to the ground, and the data line drive circuit shorts all the data output terminals when receiving the power supply off instruction. Thus, when the power supply is turned off, all the data output terminals become the same potential as the ground. Accordingly, even when a data line drive circuit having no discharging function is used, the discharge can be performed.

(14) A display device according to some embodiments of the disclosure has the above-described configuration (13), wherein all the unused terminals are electrically connected to the ground.

(15) A display device according to some embodiments of the disclosure has the above-described configuration (13), wherein some of the unused terminals are electrically connected to the ground.

(16) A display device according to some embodiments of the disclosure has the configuration of above-described (13), wherein each of the plurality of pixel circuits includes a thin film transistor formed using an oxide semiconductor.

(17) A display device according to some embodiments of the disclosure has the above-described configuration (16), wherein the oxide semiconductor is indium gallium zinc oxide.

These and other objects, features, aspects, and advantages of the disclosure will become more apparent from the following detailed description with reference to the accompanying drawings.

### BRIEF DESCRIPTION OF DRAWINGS

The disclosure will be described with reference to the accompanying drawings, wherein like numbers reference like elements.

FIG. 1 is a block diagram illustrating a configuration of a liquid crystal display device according to a first embodiment.

FIG. 2 is a diagram illustrating a configuration of a liquid crystal panel of the liquid crystal display device illustrated in FIG. 1.

FIG. 3 is an equivalent circuit diagram illustrating a circuit in a display region of the liquid crystal display device illustrated in FIG. 1.

FIG. 4 is a diagram illustrating a circuit on a control board of the liquid crystal display device illustrated in FIG. 1.

FIG. 5 is a diagram illustrating a connection form of data output terminals of the liquid crystal display device illustrated in FIG. 1.

FIG. 6 is a signal waveform diagram of a liquid crystal display device according to a comparative example.

FIG. 7 is a signal waveform diagram of the liquid crystal display device illustrated in FIG. 1.

FIG. 8 is a diagram illustrating a circuit on a control board of a liquid crystal display device according to a second embodiment.

FIG. 9 is a diagram illustrating a connection form of data output terminals of the liquid crystal display device according to the second embodiment.

FIG. 10 is a diagram illustrating a connection form of data output terminals of a liquid crystal display device according to a third embodiment.

### DESCRIPTION OF EMBODIMENTS

### First Embodiment

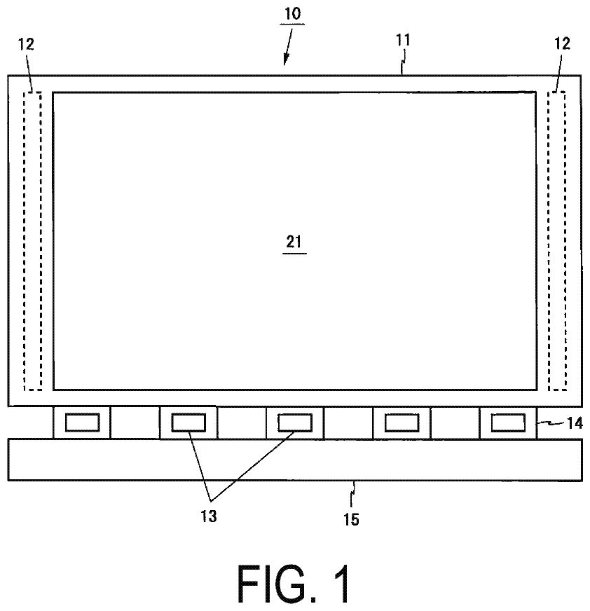

FIG. 1 is a block diagram illustrating a configuration of a liquid crystal display device according to a first embodiment. The liquid crystal display device 10 illustrated in FIG. 1 includes a liquid crystal panel 11, two scanning line drive circuits 12, five data line drive circuits 13, five flexible printed circuit boards 14, and a control board 15. Each of the scanning line drive circuits 12 is formed integrally with pixel circuits or the like on the liquid crystal panel 11, using TFTs (gate driver monolithic structure). Each of the data line drive circuits 13 is embedded in a semiconductor chip and mounted on each of the flexible printed circuit boards 14. A backlight (not illustrated) is provided on a back face of the liquid crystal panel 11.

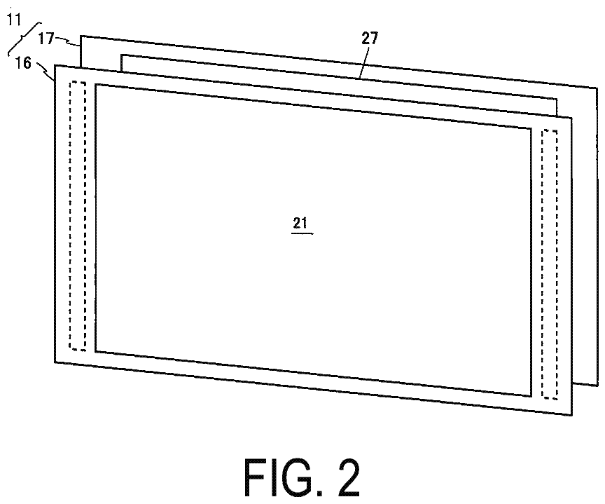

FIG. 2 is a diagram illustrating a configuration of the liquid crystal panel 11. As illustrated in FIG. 2, the liquid crystal panel 11 has a structure in which a liquid crystal (not illustrated) is sandwiched between a TFT substrate 16 and a counter substrate 17. A display region 21 is set on the TFT substrate 16, and a plurality of scanning lines, a plurality of data lines, and a plurality of pixel circuits are formed in the display region 21. The scanning line drive circuits 12 are disposed on a peripheral portion (left side and right side in FIG. 2) of the display region 21. A common electrode 27 is formed in a portion facing the display region 21 of the counter substrate 17.

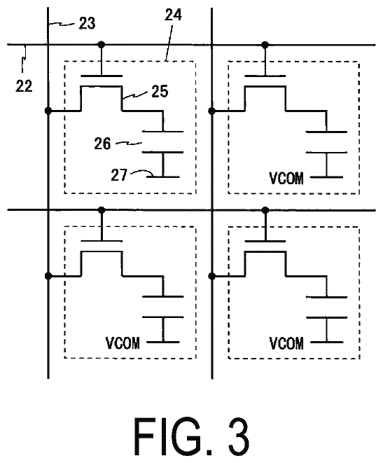

FIG. 3 is an equivalent circuit diagram of a circuit in the display region 21. As illustrated in FIG. 3, a plurality of scanning lines 22, a plurality of data lines 23, and a plurality of pixel circuits 24 are formed in the display region 21. The plurality of scanning lines 22 are disposed parallel to each other. The plurality of data lines 23 are disposed parallel to each other to be orthogonal to the plurality of scanning lines 22. Each of the plurality of pixel circuits 24 is provided corresponding to an intersection of each of the plurality of scanning lines 22 and each of the plurality of data lines 23.

The pixel circuit 24 includes a TFT 25 and a liquid crystal capacitance 26. The TFT 25 is an N-channel transistor formed using the oxide semiconductor. As the oxide semiconductor, for example, IGZO is used. A gate terminal of the TFT 25 is connected to a corresponding scanning line 22. One conduction terminal (terminal on the left side in FIG. 3) of the TFT 25 is connected to a corresponding data line 23. The other conduction terminal of the TFT 25 is connected to one electrode (pixel electrode) of the liquid crystal capacitance 26. The other electrode of the liquid crystal capacitance 26 is the common electrode 27. Note that the pixel circuit 24 may include an auxiliary capacitance in parallel with the liquid crystal capacitance 26.

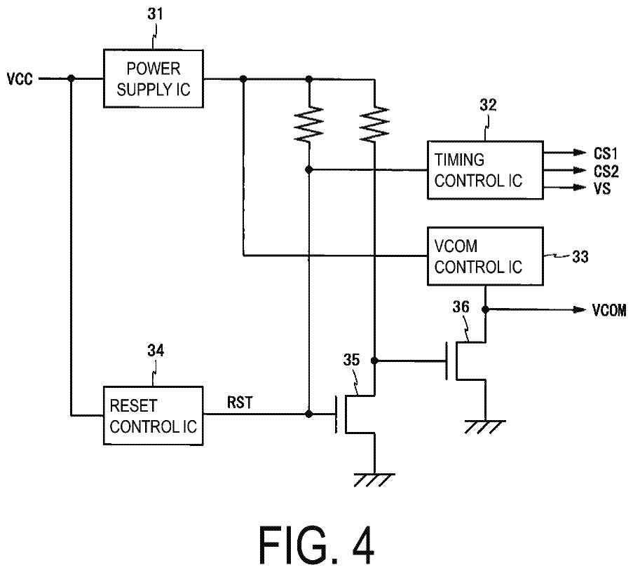

FIG. 4 is a diagram illustrating a circuit on the control board 15. As illustrated in FIG. 4, a power supply IC 31, a timing control IC 32, a VCOM control IC 33, a reset control IC 34, and two field effect transistors (hereinafter referred to as FETs) 35 and 36 are provided on the control board 15. A power supply voltage VCC supplied to the liquid crystal display device 10 is supplied to the power supply IC 31 and the reset control IC 34. The power supply IC 31 supplies a power supply voltage to the timing control IC 32 and the VCOM control IC 33 on the basis of the power supply voltage VCC.

The timing control IC 32 outputs a control signal CS1 to the scanning line drive circuit 12 and outputs a control signal CS2 and an image signal VS to the data line drive circuit 13, using the supplied power supply voltage. The VCOM control IC 33 outputs a common electrode voltage VCOM to be applied to the common electrode 27, using the supplied power supply voltage. The reset control IC 34 and the FETs 35 and 36 will be described later.

The scanning line drive circuit 12 drives the plurality of scanning lines 22 on the basis of the control signal CS1. The data line drive circuit 13 drives the plurality of data lines 23 on the basis of the control signal CS2 and the image signal VS. Note that although the scanning line drive circuit 12 is provided on both sides of the display region 21 in FIG. 1, the scanning line drive circuit 12 may be provided on one side of the display region 21.

The data line drive circuit 13 includes n (n is an integer of 2 or more) data output terminals. The data line drive circuit 13 switches the number (equal to the number of the data output terminals used) of data lines 23 to be driven according to an operation mode. n data output terminals are classified into use terminals electrically connected to the data lines 23 and unused terminals not electrically connected to the data lines 23, according to the operation mode. In the following description, the data line drive circuit 13 is assumed to operate in an operation mode in which (n−6) data lines are driven. In this case, the n data output terminals are classified into (n−6) use terminals and six unused terminals.

Hereinafter, the operation of the liquid crystal display device 10 when the power supply is turned off will be described. The liquid crystal display device 10 performs a predetermined sequence of processes (hereinafter referred to as an off sequence) when the power supply is turned off. A control signal (not illustrated) indicating whether it is during the off sequence or during normal operation is input to the data line drive circuit 13. The data line drive circuit 13 shorts all the data output terminals (including unused terminals) during the off sequence according to the control signal. In this manner, the data line drive circuit 13 shorts all the data output terminals when receiving a power supply off instruction. On the other hand, the data line drive circuit 13 has no discharging function (a function of setting all the data output terminals to the same potential as that of the common electrode or the ground when the power supply is turned off).

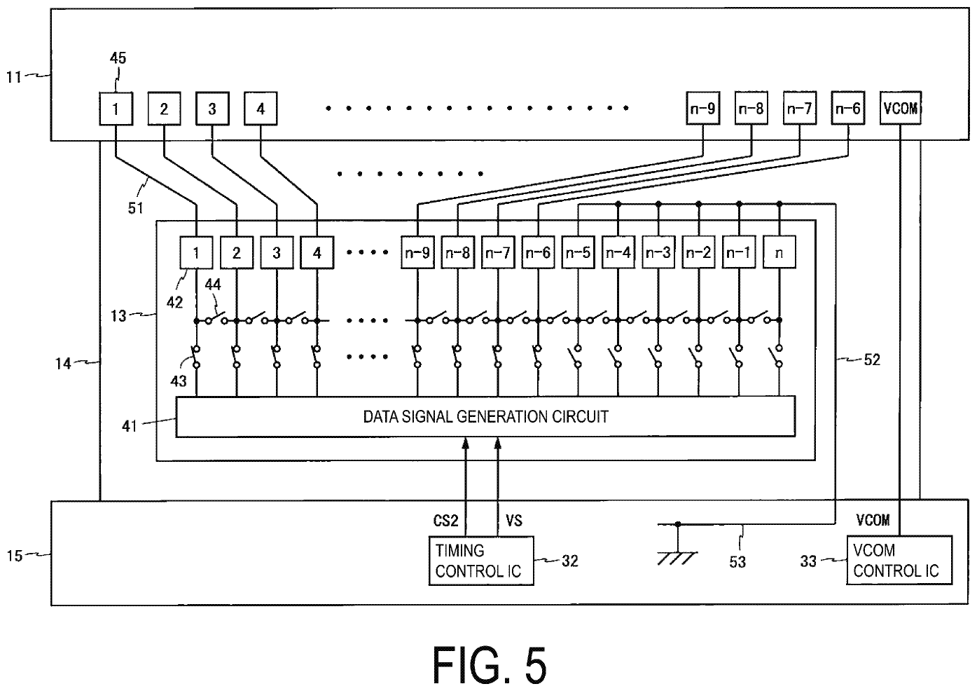

FIG. 5 is a diagram illustrating a connection form of a data output terminal. As illustrated in FIG. 5, the data line drive circuit 13 includes a data signal generation circuit 41, n data output terminals 42, n first switches 43, and (n−1) second switches 44. The first switches 43 are provided between the data signal generation circuit 41 and the data output terminals 42. Each of the second switches 44 is provided between two adjacent data output terminals 42. The liquid crystal panel 11 includes (n−6) input terminals 45 corresponding to (n−6) use terminals. A corresponding data line (not illustrated) is connected to each of the input terminals 45.

Each of the (n−6) use terminals is electrically connected to the data line of the liquid crystal panel 11 via each of wiring lines 51 on the flexible printed circuit board 14 and each of the input terminal 45. The six unused terminals are all electrically connected to the ground. Specifically, the six unused terminals are electrically connected to a ground wiring line 53 on the control board 15 via a wiring line 52 on the flexible printed circuit board 14.

During the normal operation, the first switches 43 connected to the use terminals turn on, and the first switches 43 connected to the unused terminals and all the second switches 44 turn off. At this time, each of the (n−6) output signals of the data signal generation circuit 41 is applied to the data line of the liquid crystal panel 11 via each of the first switches 43, each of the data output terminals 42, each of the wiring lines 51, and each of the input terminals 45. The unused terminals are in a high impedance state during the normal operation. Thus, the unused terminals do not affect the normal operation of the data line drive circuit 13.

During the off sequence, all the first switches 43 are turned off, and all the second switches 44 are turned on. At this time, the output signals of the data signal generation circuit 41 are not applied to the data line. The data line drive circuit 13 shorts all the data output terminals 42 (including the unused terminals) during the off sequence. Since the six unused terminals are electrically connected to the ground, potentials of all the data output terminals 42 become the ground level during the off sequence.

In FIG. 4, the FETs 35 and 36 are N-channel transistors. The reset control IC 34 changes the reset signal RST from the high level to the low level when detecting a decrease in the power supply voltage VCC. Accordingly, the FET 35 is turned off, and the FET 36 is turned on. Thus, during the off sequence, the common electrode voltage VCOM becomes the ground level, and a potential of the common electrode 27 also becomes the ground level. In this manner, the liquid crystal display device 10 is provided with a circuit (a circuit including the reset control IC 34 and the FETs 35 and 36) that sets the potential of the common electrode 27 to the ground level when receiving the power supply off instruction.

In the liquid crystal display device 10, all the unused terminals of the data line drive circuit 13 are electrically connected to the ground. The data line drive circuit 13 shorts all the data output terminals 42 when receiving the power supply off instruction. The circuit on the control board 15 sets the potential of the common electrode 27 to the ground level when receiving the power supply off instruction. Thus, when the power supply is turned off, all the data output terminals 42 and the common electrode 27 become the same potential (ground level). Thus, according to the liquid crystal display device 10, even in a case where the data line drive circuit 13 having no discharging function is used, the discharge can be performed. Furthermore, since the data line drive circuit 13 having no discharging function can be used, options of the data line drive circuit 13 can be opened up.

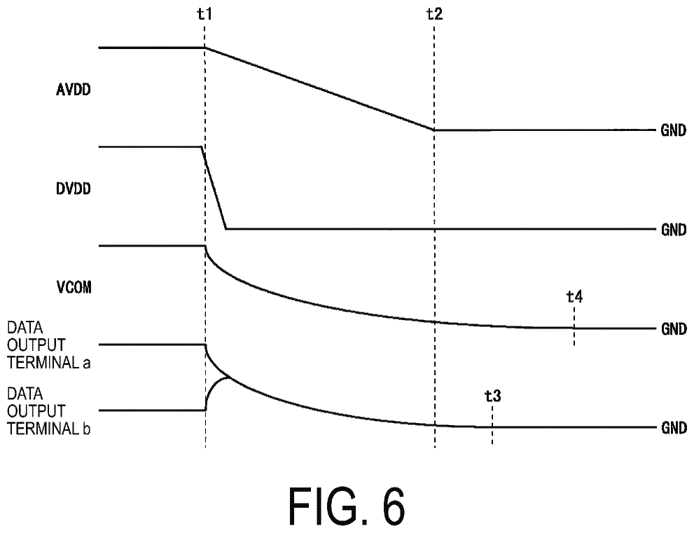

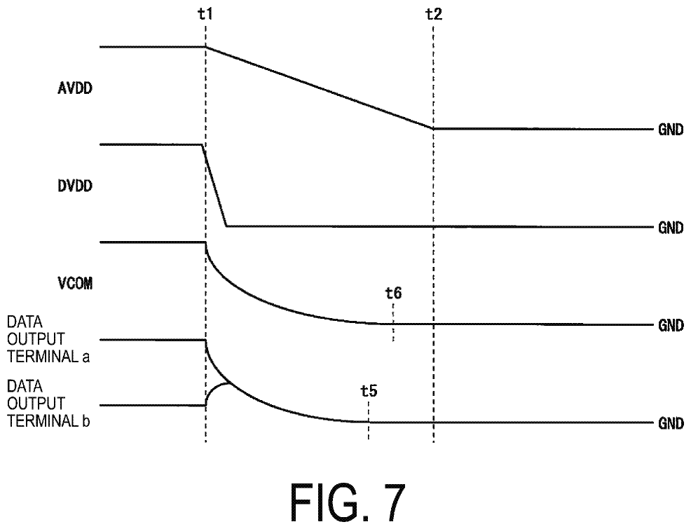

As a liquid crystal display device according to a comparative example, a liquid crystal display device including a data line drive circuit having no discharging function and unused terminals of the data line drive circuit in an open state will be considered. FIG. 6 is a signal waveform diagram of a liquid crystal display device according to a comparative example. FIG. 7 is a signal waveform diagram of the liquid crystal display device 10 according to the present embodiment. In FIG. 6 and FIG. 7, AVDD denotes an analog power supply voltage, DVDD denotes a digital power supply voltage, VCOM denotes a common electrode voltage, data output terminal a denotes a voltage of one data output terminal, data output terminal b denotes a voltage of another data output terminal, t1 denotes an off sequence start time, and t2 denotes an off sequence end time.

In the liquid crystal display device according to the comparative example (FIG. 6), the data line drive circuit include no discharging function, and the discharge is not performed. Thus, voltages of the data output terminals a and b reach the ground level at the time t3, and the common electrode voltage VCOM reaches the ground level at the time t4. When the times t3 and t4 are later than the off sequence end time t2, a difference occurs between the voltage of the data output terminals a and b and the common electrode voltage VCOM at the time t2. When such a difference occurs, an afterimage is displayed on the display screen after the power supply is turned off.

In contrast, in the liquid crystal display device 10 according to the present embodiment (FIG. 7), the data line drive circuit 13 has no discharging function, but the discharge is performed. Thus, the voltages of the data output terminals a and b reach the ground level at the time t5, and the common electrode voltage VCOM reaches the ground level at the time t6. The times t5 and t6 are earlier than the times t3 and t4, respectively. When the times t5 and t6 are earlier than the off sequence end time t2, a difference does not occur between the voltage of the data output terminals a and b and the common electrode voltage VCOM at the time t2. Accordingly, in the liquid crystal display device 10, the afterimage can be prevented from being displayed on the display screen after the power supply is turned off.

As described above, the display device (liquid crystal display device 10) according to the present embodiment includes the display panel (liquid crystal panel 11) including the plurality of data lines 23, the plurality of pixel circuits 24, and the common electrode 27, and the plurality of data output terminals 42 each configured to output a voltage to be applied to each of the plurality of data lines 23, and is provided with a data line drive circuit 13 configured to short all the data output terminals 42 when receiving the power supply off instruction and the circuit (a circuit including the reset control IC 34 and the FETs 35 and 36) configured to set the potential of the common electrode 27 to the ground level when receiving the power supply off instruction. The data output terminals 42 are classified into the use terminals electrically connected to the data lines 23 and the unused terminals not electrically connected to the data lines 23, and all the unused terminals are electrically connected to the ground. Each of the plurality of pixel circuits 24 includes the thin film transistor (TFT 25) formed using the oxide semiconductor such as IGZO.

In the display device according to the present embodiment, all the unused terminals are electrically connected to the ground, the data line drive circuit 13 shorts all the data output terminals 42 when receiving the power supply off instruction, and the potential of the common electrode 27 becomes the ground level when the data line drive circuit 13 receives the power supply off instruction. Thus, when the power supply is turned off, all the data output terminals 42 become the same potential as that of the common electrode 27 and the ground. Thus, even when the data line drive circuit 13 having no discharging function is used, the discharge can be performed.

### Second Embodiment

A liquid crystal display device according to a second embodiment has the same configuration as that of the liquid crystal display device 10 according to the first embodiment (refer to FIG. 1 to FIG. 3). The present embodiment differs from the first embodiment in the connection form of the unused terminals of the data line drive circuit 13. Hereinafter, differences from the first embodiment will be described.

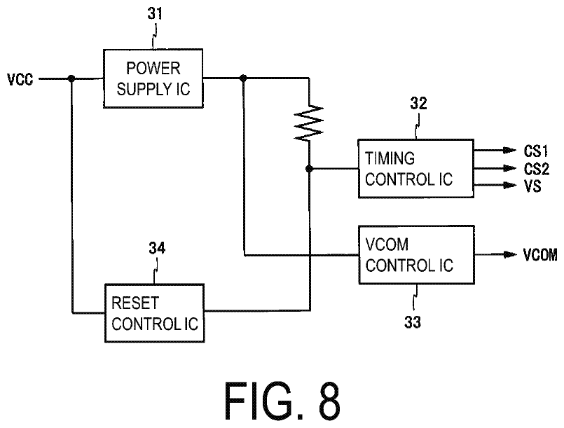

FIG. 8 is a diagram illustrating a circuit on the control board 15 of a liquid crystal display device according to the present embodiment. The circuit illustrated in FIG. 8 is obtained by removing the FETs 35 and 36 from the circuit illustrated in FIG. 4. The liquid crystal display device according to the present embodiment does not include a circuit configured to set the potential of the common electrode 27 to the ground level when receiving the power supply off instruction.

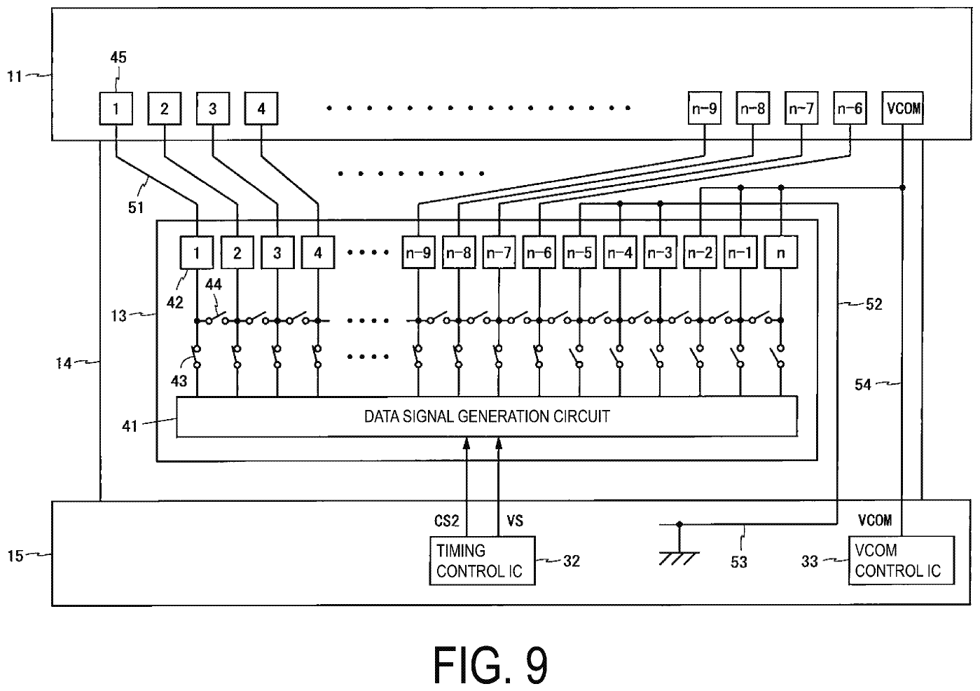

FIG. 9 is a diagram illustrating a connection form of a data output terminal of the liquid crystal display device according to the present embodiment. Similar to the first embodiment, the n data output terminals 42 are classified into (n−6) use terminals and six unused terminals. In the liquid crystal display device according to the present embodiment, some of the unused terminals are electrically connected to the ground, and the remaining unused terminals are electrically connected to the common electrode 27. Specifically, the three unused terminals are electrically connected to a ground wiring line 53 on the control board 15 via a wiring line 52 on the flexible printed circuit board 14. The remaining three unused terminals are connected to a wiring line 54 formed on the flexible printed circuit board 14 for applying a common electrode voltage VCOM to the common electrode 27.

A first switch 43 and a second switch 44 operate similar to the first embodiment during the normal operation and during the off sequence. The data line drive circuit 13 shorts all the data output terminals 42 (including the unused terminals) during the off sequence. Since the three unused terminals are electrically connected to the ground and the three unused terminals are electrically connected to the common electrode 27, all the data output terminals 42 become the same potential as that of the common electrode 27 and the ground during the off sequence.

As described above, in the display device (liquid crystal display device 10) according to the present embodiment, some unused terminals are electrically connected to the ground, and the remaining unused terminals are electrically connected to the common electrode 27. Thus, according to the display device of the present embodiment, similar to the first embodiment, even when the data line drive circuit 13 having no discharging function is used, the discharge can be performed.

### Third Embodiment

A liquid crystal display device according to a third embodiment has the same configuration as that of the liquid crystal display device 10 according to the first embodiment (refer to FIG. 1 to FIG. 3). The present embodiment differs from the first embodiment and the second embodiment in the connection form of the unused terminals of the data line drive circuit 13. Hereinafter, differences from the second embodiment will be described.

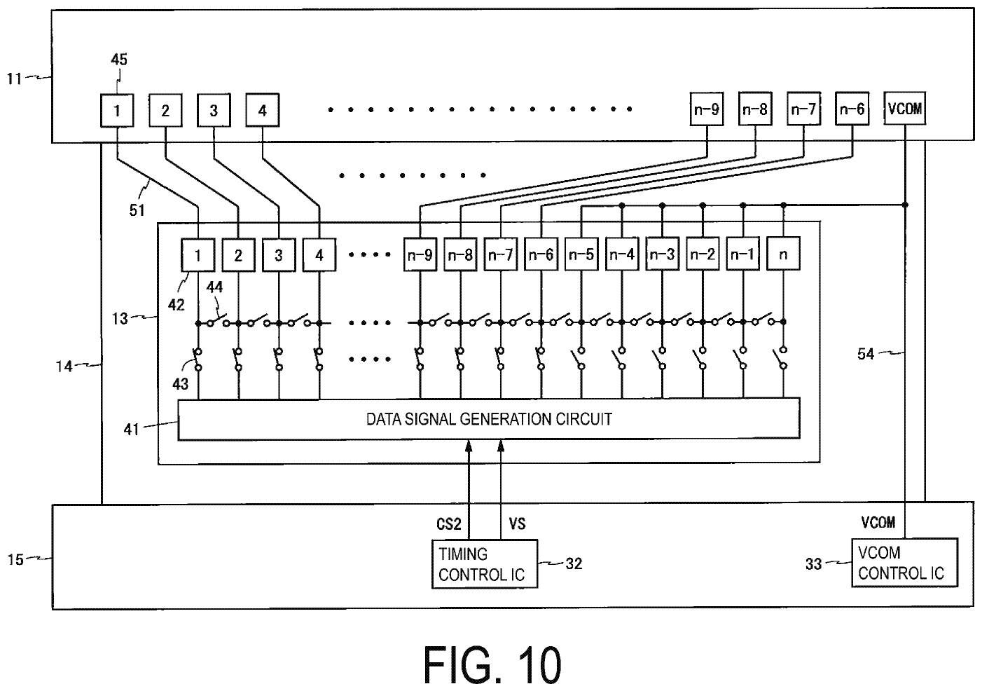

FIG. 10 is a diagram illustrating a connection form of a data output terminal of the liquid crystal display device according to the present embodiment. Similar to the first embodiment and the second embodiment, n data output terminals 42 are classified into (n−6) use terminals and six unused terminals. In the liquid crystal display device according to the present embodiment, all the unused terminals are electrically connected to the common electrode 27. Specifically, the six unused terminals are connected to a wiring line 54 formed on the flexible printed circuit board 14 for applying a common electrode voltage VCOM to the common electrode 27.

A first switch 43 and a second switch 44 operate similar to the first embodiment and the second embodiment during the normal operation and during the off sequence. The data line drive circuit 13 shorts all the data output terminals 42 (including the unused terminals) during the off sequence. Since the six unused terminals are electrically connected to the common electrode 27, all the data output terminals 42 become the same potential as that of the common electrode 27 during the off sequence.

As described above, in the display device (liquid crystal display device 10) according to the present embodiment, all the unused terminals are electrically connected to the common electrode 27. According to the liquid crystal display device of the present embodiment, similar to the first embodiment and the second embodiment, even when the data line drive circuit 13 having no discharging function is used, the discharge can be performed.

In the second embodiment, the unused terminals electrically connected to the ground and the unused terminals electrically connected to the common electrode 27 are required. In contrast, in the first embodiment, the unused terminals electrically connected to the ground is required, and in the present embodiment, the unused terminals electrically connected to the common electrode 27 is required. Accordingly, the first embodiment and the present embodiment can also apply to a liquid crystal display device in which the number of unused terminals is less than that of the second embodiment.

The following modification can be configured for the liquid crystal display device according to each of the embodiments. In the liquid crystal display device according to the first embodiment, all the unused terminals are electrically connected to the ground. In the liquid crystal display device according to the modification, some of the unused terminals may be electrically connected to the ground. In the liquid crystal display device according to the second embodiment, some of the unused terminals are electrically connected to the ground, and the remaining unused terminals are electrically connected to the common electrode 27. In the liquid crystal display device according to the modification, some of the unused terminals may be electrically connected to the ground and some of the remaining unused terminals may be electrically connected to the common electrode 27. In the liquid crystal display device according to the third embodiment, all the unused terminals are electrically connected to the common electrode 27. In the liquid crystal display device according to the modification, all the unused terminals may be electrically connected to the common electrode 27. In this manner, in the liquid crystal display device according to each of the embodiments and the modification, at least some of the unused terminals may be electrically connected to either the ground or the common electrode 27. The number of the unused terminals electrically connected to the ground or the common electrode 27 may be determined according to the configuration of the liquid crystal display device.

Furthermore, when the display device includes a display panel including no common electrode, at least some of the unused terminals may be electrically connected to the ground. In this case, all the unused terminals may be electrically connected to the ground, or some of the unused terminals may be connected to the ground.

Although the disclosure has been described in detail above, the above description is exemplary in all respects and is not limiting. It is understood that numerous other modifications or variations can be made without departing from the scope of the disclosure.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A display device comprising:
a display panel including a plurality of data lines, a plurality of pixel circuits, and a common electrode; and
a data line drive circuit including a plurality of data output terminals each configured to output a voltage to be applied to each of the plurality of data lines and configured to short all the plurality of data output terminals when receiving a power supply off instruction,
wherein the plurality of data output terminals are classified into use terminals electrically connected to the plurality of data lines and unused terminals not electrically connected to the plurality of data lines, and
at least some of the unused terminals are electrically connected to either the ground or the common electrode.

2. The display device according to claim 1,
wherein all the unused terminals are electrically connected to the ground.

3. The display device according to claim 2, further comprising:
a circuit configured to set a potential of the common electrode to the ground level when receiving the power supply off instruction.

4. The display device according to claim 1,
wherein some of the unused terminals are electrically connected to the ground, and the remaining unused terminals are electrically connected to the common electrode.

5. The display device according to claim 1,
wherein all the unused terminals are electrically connected to the common electrode.

6. The display device according to claim 1,
wherein some of the unused terminals are electrically connected to the ground.

7. The display device according to claim 6, further comprising:
a circuit configured to set a potential of the common electrode to the ground level when receiving the power supply off instruction.

8. The display device according to claim 1,
wherein some of the unused terminals are electrically connected to the ground, and some of the remaining unused terminals are electrically connected to the common electrode.

9. The display device according to claim 1,
wherein some of the unused terminals are electrically connected to the common electrode.

10. The display device according to claim 1,
wherein the display panel is a liquid crystal panel.

11. The display device according to claim 1,
wherein each of the plurality of pixel circuits includes a thin film transistor formed using an oxide semiconductor.

12. The display device according to claim 11,
wherein the oxide semiconductor is indium gallium zinc oxide.

13. A display device comprising:
a display panel including a plurality of data lines and a plurality of pixel circuits; and
a data line drive circuit including a plurality of data output terminals each configured to output a voltage to be applied to each of the plurality of data lines and configured to short all the plurality of data output terminals when receiving a power supply off instruction,
wherein the plurality of data output terminals are classified into use terminals electrically connected to the plurality of data lines and unused terminals not electrically connected to the plurality of data lines, and
at least some of the unused terminals are electrically connected to the ground.

14. The display device according to claim 13,
wherein all the unused terminals are electrically connected to the ground.

15. The display device according to claim 13,
wherein some of the unused terminals are electrically connected to the ground.

16. The display device according to claim 13,
wherein each of the plurality of pixel circuits includes a thin film transistor formed using an oxide semiconductor.

17. The display device according to claim 16,
wherein the oxide semiconductor is indium gallium zinc oxide.
